(19) United States
(12) Patent Application Publication
(10) Pub. No.: US 2026/0153272 A1
(43) Pub. Date: Jun. 4, 2026

(54) PARTICLE FLOW CONTROL SYSTEM

(71) Applicants: The University of Tulsa, Tulsa, OK (US); Western Washington University, Bellingham, WA (US); Boise State University, Boise, ID (US)

(72) Inventors: Soroor Karimi, Tulsa, OK (US); Nipun Goel, Mount Vernon, WA (US); Todd Otanicar, Boise, ID (US)

(73) Assignees: The University of Tulsa, Tulsa, OK (US); Western Washington University, Bellingham, WA (US); Boise State University, Boise, ID (US)

(21) Appl. No.: 19/100,909

(22) PCT Filed: Aug. 30, 2023
(86) PCT No.: PCT/US2023/031486

§ 371 Date: Feb. 3, 2025

Related U.S. Application Data
(60) Provisional application No. 63/421,337, filed on Nov. 1, 2022.

(51) Int. Cl. F24S 50/00; F24S 10/00; F24S 20/20; F24S 80/20

(52) U.S. Cl. CPC F24S 50/00; F24S 10/00; F24S 20/20; F24S 80/20

(57) ABSTRACT

A material flow control system. In one embodiment, the flow control system includes an elongated flow control body, the body having an axial passage therethrough, wherein the axial passage is in communication with a heat exchanger and in communication with low temperature storage. Each of a plurality of fingers are received in an opening passing through the flow control body into the axial passage, each opening at an angle to the axial passage, wherein the plurality of fingers together form a nozzle for passage of heat transfer material therethrough. A mechanism actuates movement of each of said plurality of fingers in said elongated flow control body.

### 2. CROSS-REFERENCE TO RELATED APPLICATIONS

This application is based on and claims priority to U.S. Provisional Patent Application No. 63/421,337 filed Nov. 1, 2022, which is incorporated herein in its entirety by reference.

### 1. FEDERALLY SPONSORED RESEARCH OR DEVELOPMENT

This invention was made with government support under DE-EE0010251 awarded by the U.S. Department of Energy. The U.S. Government may have rights in this invention.

### BACKGROUND OF THE INVENTION

### 3. Field of the Invention

The present invention is directed to a material flow control system to distribute and to control flow of particulate heat transfer material. In one embodiment, the present invention is directed to a particulate material flow control system for concentrating solar power.

### 4. Description of the Related Art

Concentrating solar power (CSP) is a solar electricity generation technology that captures and stores the sun's energy in the form of heat, using materials that are low cost and stable. This makes CSP with thermal energy storage (TES) effective to deliver renewable energy while providing important reliability and stability to the electric grid.

CSP technologies use mirrors to reflect and concentrate sunlight onto receivers that collect solar energy and convert it to heat. This thermal energy can then be used to produce electricity via turbine (for example, steam, air, or supercritical carbon dioxide) or other type of heat engine that drives an electric generator.

Various types of heat transfer materials may be utilized such as solid particles, air, water/steam, molten salt, or oils which are pumped from a cold storage tank to a solar receiver, where concentrated sunlight heats the heat transfer materials. The hot heat transfer materials are held in a storage tank, and when electric power generation is required, the hot materials are pumped to the heat engine to generate electricity. The now-cooler heat transfer materials are returned to a lower temperature storage tank to complete the cycle.

One immediate application of the present invention would be in particle-based Concentrating Solar Power (CSP) Systems. A variety of ceramic or silica based particles may be employed as heat transfer material. With particles as the heat transfer medium, flow rate is directly related to the rate of heat generation in electric power plants. Accordingly, it is desirable to control the flow rate and the distribution of particle heat transfer material.

In the case of particle heat transfer materials, wear on system components from abrasion is another issue. It is also desirable to provide a material flow control system to distribute and to control flow of heat transfer material.

It is also desirable to provide a material flow control system which dynamically varies flow based on system demands.

### SUMMARY OF THE INVENTION

The present invention is directed to a particulate material flow control system to distribute and to control flow of particulate material.

In one embodiment of the invention, the present invention is directed to a solid particulate flow control system for heat transfer material for use in a concentrating solar power system wherein heat transfer material falls by gravity from a solar receiver, high temperature storage, a heat exchanger, and low temperature storage.

An elongated flow control body has an axial passage therethrough. A plurality of fingers is each received in a plurality of openings passing through said flow control body in the axial passage. Each opening is at an acute angle to the axial passage. The plurality of fingers together forms a nozzle for passage of the particulate material.

The solid particulate material may be ceramic or silica-based particles.

A mechanism actuates movement of each of the plurality of fingers in the elongated flow control body in order to dynamically vary the nozzle and the flow of material.

### BRIEF DESCRIPTION OF THE DRAWINGS

FIG. 1 illustrates a simplified diagrammatic view of one application of the present invention in use with a concentrating solar system;

FIG. 2 illustrates an enlarged diagrammatic view of a portion of a concentrating solar system in a falling particle tower arrangement;

FIG. 3 illustrates a front view of a first preferred embodiment of a material flow control system constructed in accordance with the present invention;

FIG. 4 illustrates a series of images of a further alternate embodiment of the material flow control system;

FIG. 5 illustrates a series of images of a further alternate embodiment of the flow control system;

FIG. 6 illustrates a series of images of a further alternate embodiment of the flow control system;

FIG. 7 illustrates a series of images of yet another alternate embodiment of the flow control system;

FIG. 8 illustrates a series of images of a further alternate embodiment of the flow control system;

FIG. 9 illustrates a series of images of a further alternate embodiment of the flow control system;

FIG. 10 illustrates a bottom view of a further alternate embodiment of the flow control system with closed jaws;

FIG. 11 illustrates a bottom view of the flow control system of FIG. 10 with open jaws; FIG. 12 illustrates a perspective view of the flow control system of FIG. 10;

FIG. 13 illustrates a front view of the flow control system of FIG. 10 showing line A-A:

FIG. 14 illustrates a sectional view of FIG. 14 taken along line A-A;

FIG. 15 illustrates an exploded view of the flow control system of FIG. 10;

FIG. 16 illustrates a perspective view of the flow control system of FIG. 10;

FIG. 17 illustrates a perspective view of a jaw of the flow control system of FIG. 10;

FIG. 18 illustrates a closeup view of the jaw tip of the flow control system of FIG. 10;

FIG. 19 illustrates a bottom view of a further alternate embodiment of the flow control system with closed jaws;

FIG. 20 illustrates a perspective view of the flow control system of FIG. 19;

FIG. 21 illustrates a front view of the flow control system of FIG. 19;

FIG. 22 illustrates a front view of the flow control system of FIG. 19 showing line A-A;

FIG. 23 illustrates a sectional view of FIG. 22 taken along line A-A; and

FIG. 24 illustrates an exploded view of the flow control system of FIG. 19.

### DETAILED DESCRIPTION OF THE INVENTION

The embodiments discussed herein are merely illustrative of specific manners in which to make and use the invention and are not to be interpreted as limiting the scope.

While the invention has been described with a certain degree of particularity, it is to be noted that many modifications may be made in the details of the invention's construction and the arrangement of its components without departing from the scope of this disclosure. It is understood that the invention is not limited to the embodiments set forth herein for purposes of exemplification.

The present invention is directed to a material flow control system to distribute and to control flow of particulate heat transfer material. The mass flow of particles must be controlled and distributed to accommodate and to optimize operating conditions.

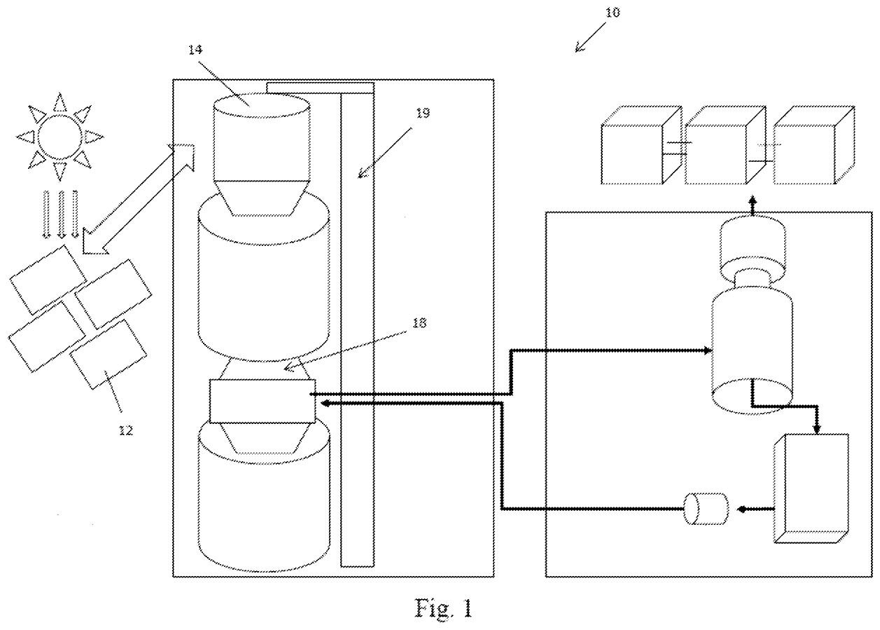

Referring to the drawings in detail, FIG. 1 illustrates a simplified diagrammatic view of one application of the present invention in use with a concentrating solar system 10. A plurality of mirrors or heliostats 12 direct sunlight to a solar receiver 14 arranged on a tower. Heat transfer material (illustrated by arrows 18) is heated and used in production of electricity. Thereafter, the cooled heat transfer material (illustrated by arrows 19) is returned to the solar receiver and the process operates in a continuous cycle.

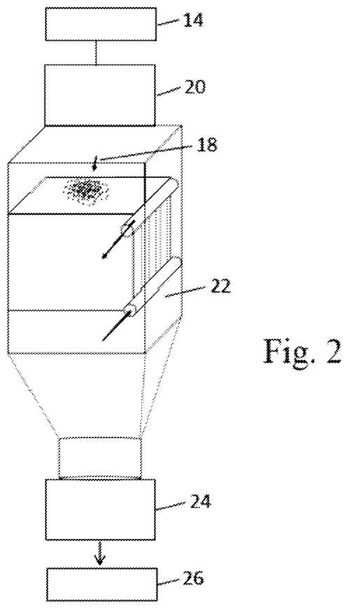

FIG. 2 illustrates an enlarged diagrammatic view of a portion of the concentrating solar system 10 in a falling particle tower arrangement. After heating in the solar receiver 14, the heat transfer material is held in high temperature storage 20 and thereafter delivered by gravity to a heat exchanger 22. The heat transfer material passes through an elongated flow control body 24 (to be described in detail) and thereafter to low temperature storage 26. The heat transfer material is returned to be heated in the solar receiver and the process continues in a continuous cycle.

The flow control system of the present invention dynamically controls movement of particulate matter through the process.

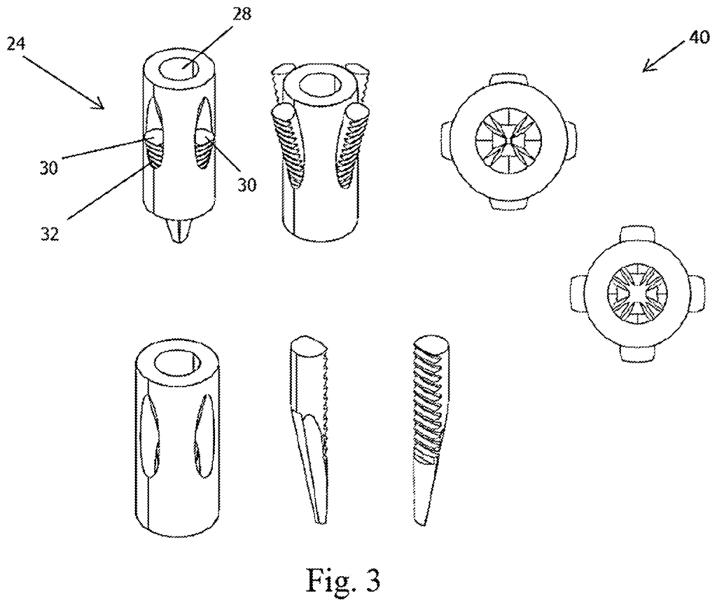

FIG. 3 illustrates a first preferred embodiment of the material flow control system having a flow control body 24, which is elongated and includes an axial passage 28 therethrough. A plurality of fingers 30 are arranged in openings in the body in a radial pattern. The openings pass through the flow control body into the axial passage 28 and are at an acute angle to the axial passage 28.

The fingers 30 together form a nozzle for passage of particulate heat transfer material therethrough. While four fingers are shown, it should be understood that a greater or lesser number may be employed. The fingers 30 are capable of moving coincidentally to the axis of the openings in the body. An actuator (not shown) will dynamically move the fingers 30.

The fingers 30 may include optional notches or teeth 32.

FIG. 3 further illustrates a series of images showing the first preferred embodiment 40 of the material flow control system. The angle of the axis of the openings in the flow control body to the vertical axis of the body may be decreased. In addition, each of the fingers may be slightly tapered at the bottom. Because of the decreased angle, both the length of the fingers and the body may be increased.

FIG. 4 illustrates a series of images showing a further alternate embodiment 50 of the material flow control system. The fingers are cylindrical with an extruded cut. The flow control body contains openings that are flush with the extruded cut of the fingers. The tip of each finger contains an extruded cut to create a vertical edge. In this embodiment, the tip is at a 90-degree angle with the tip cut off.

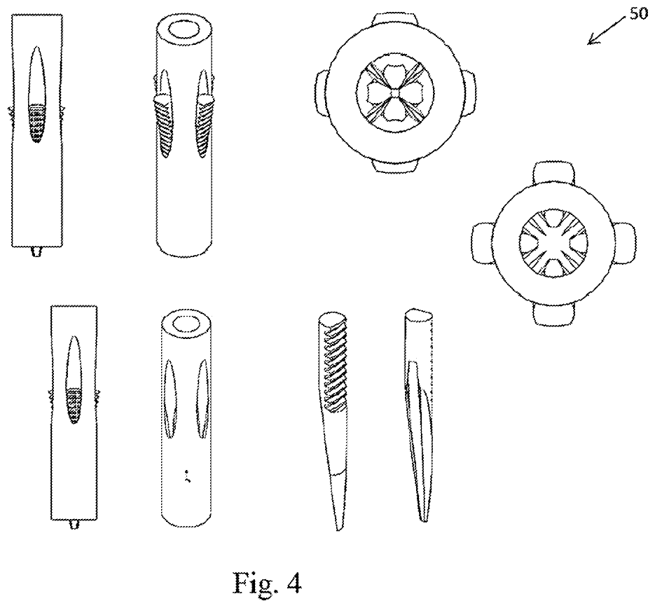

FIG. 5 illustrates a series of images showing a further alternate embodiment of the flow control system 60.

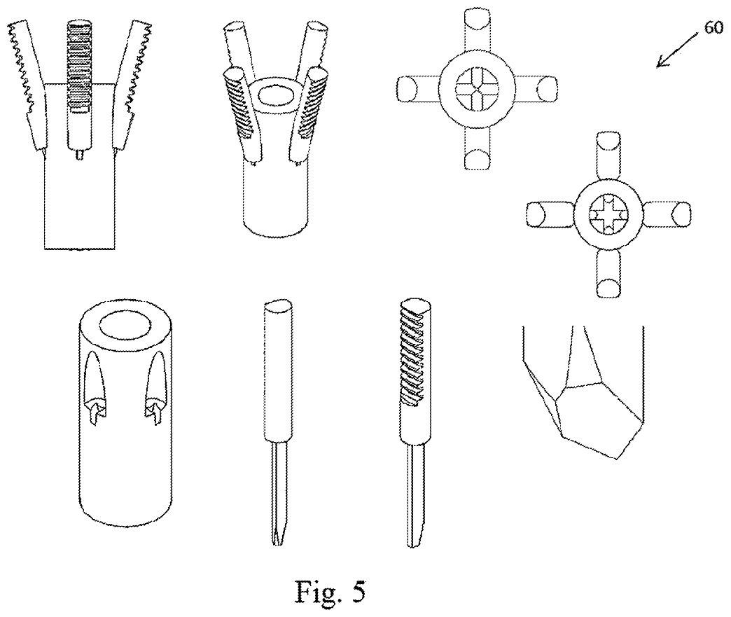

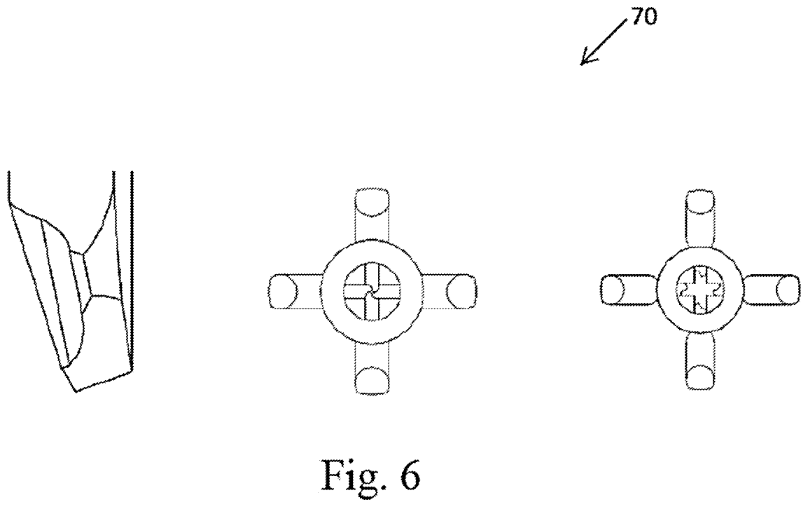

FIG. 6 illustrates a series of images of a further alternate embodiment of the flow control system 70. The extruded cut at the tip of the fingers differs in shape and creates a spiral like shape when fully closed.

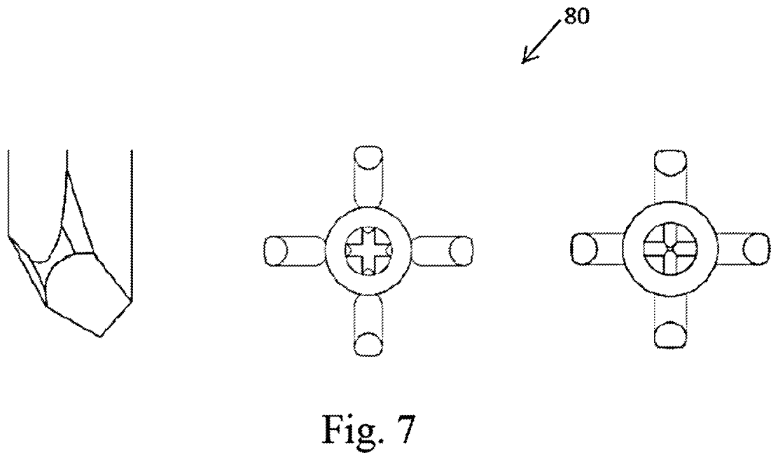

FIG. 7 is yet another alternate design for the flow control system 80 and only differs at the tip of the fingers. The extruded cut at the tip is rounded instead of flat.

A further alternate embodiment 90 of the flow control system in FIG. 8 is based on the general design of FIGS. 4, 5, and 6. The thread on the fingers has been moved to the inside to maintain contact between them and the body. The body has been increased in length and thickness. The diameter of the inner cut out remains the same.

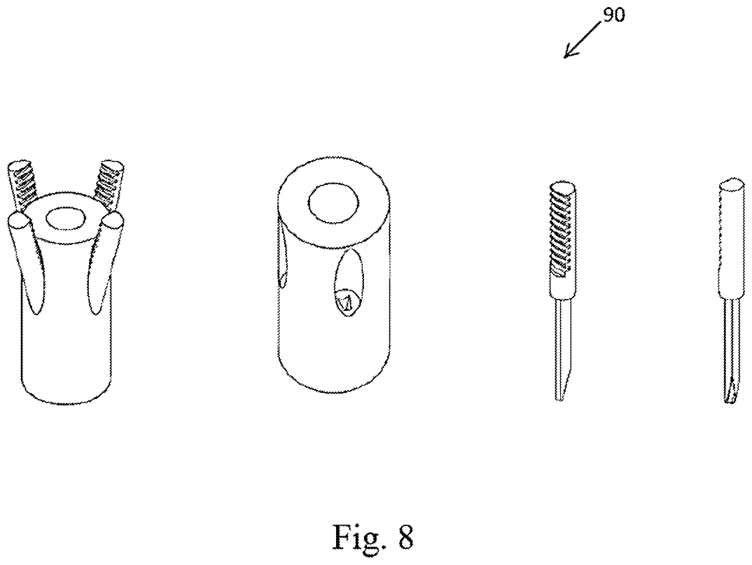

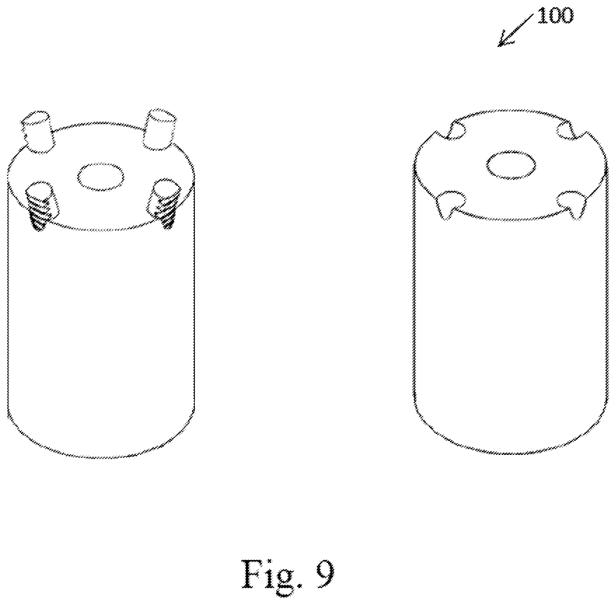

A further alternate embodiment 100 of the flow control system is illustrated in FIG. 9 and is based on the general design of FIGS. 4, 5, and 6. The finger design remains the same. The body has been increased greatly in thickness. The diameter of the inner cut out remains the same.

It will be appreciated that the present invention will allow dynamic control and distribution of particulate heat transfer material.

Returning to a consideration of FIG. 2, an additional flow control system might be employed between the low temperature storage 26 and the solar receiver 14.

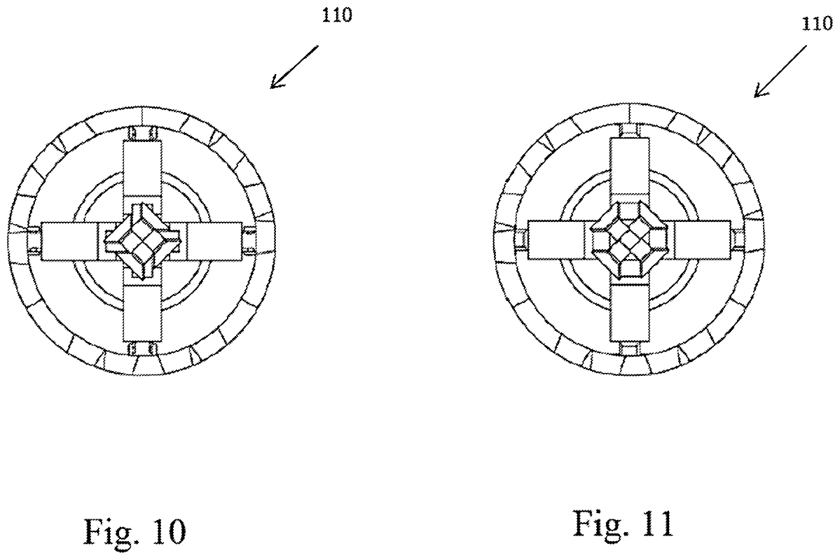

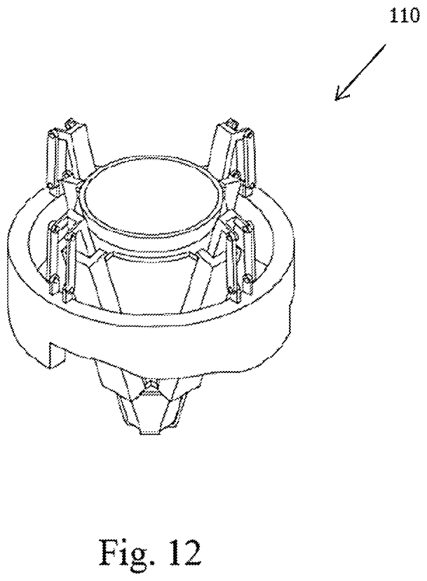

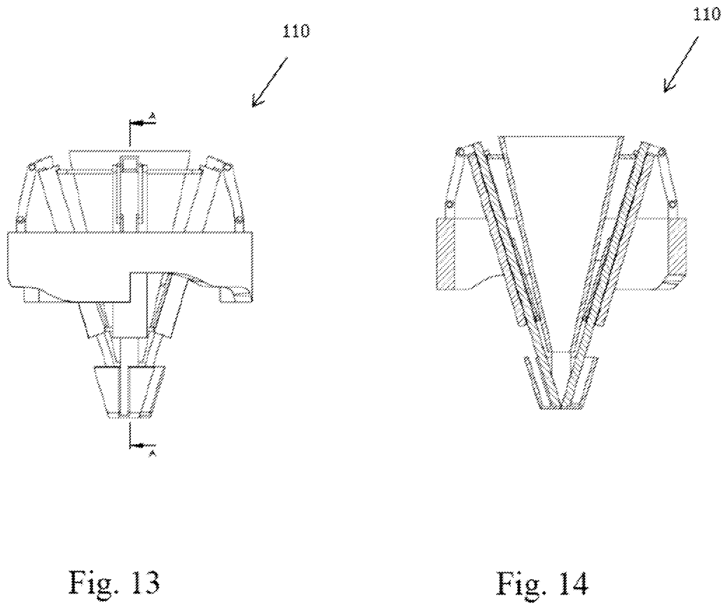

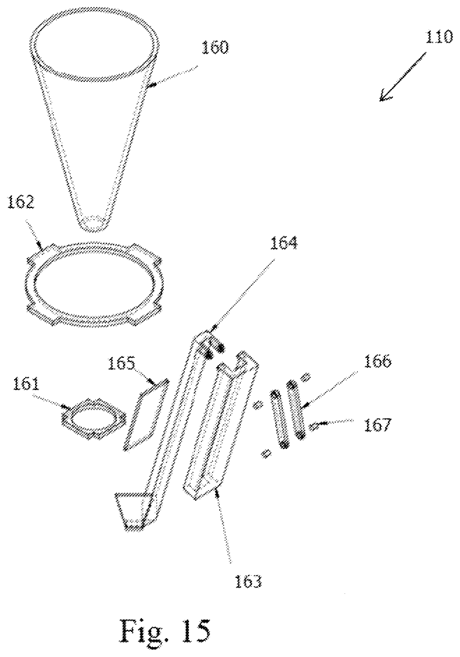

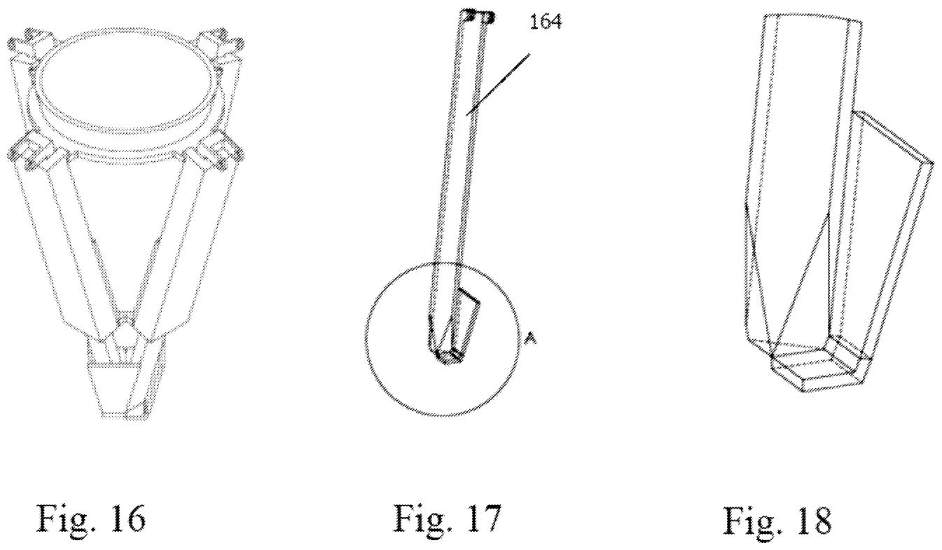

FIGS. 10 through 18 illustrate a further alternate embodiment 110 of the flow control system. This design brings together all concepts of the previously-described concepts to provide complete closure of the nozzle through the use of a lip-like extension on the jaw tip. This may prevent leakage of particles from between adjacent jaws at the nozzle opening. Simultaneous and synchronized movement of the jaws may be accomplished by using a circular ring that can move up and down. Another benefit of this design is that the jaws and jaw channel may be moved completely outside the nozzle, which may reduce the reverse flow of particles up the jaw channels. Specifically, this embodiment may comprise a funnel 160, a lower angle ring 161, an upper angle ring 162, a plurality of jaw guides 163, a plurality of jaws 164, a a plurality of jaw backplates 165, a plurality of links 166, and a plurality of pins 167.

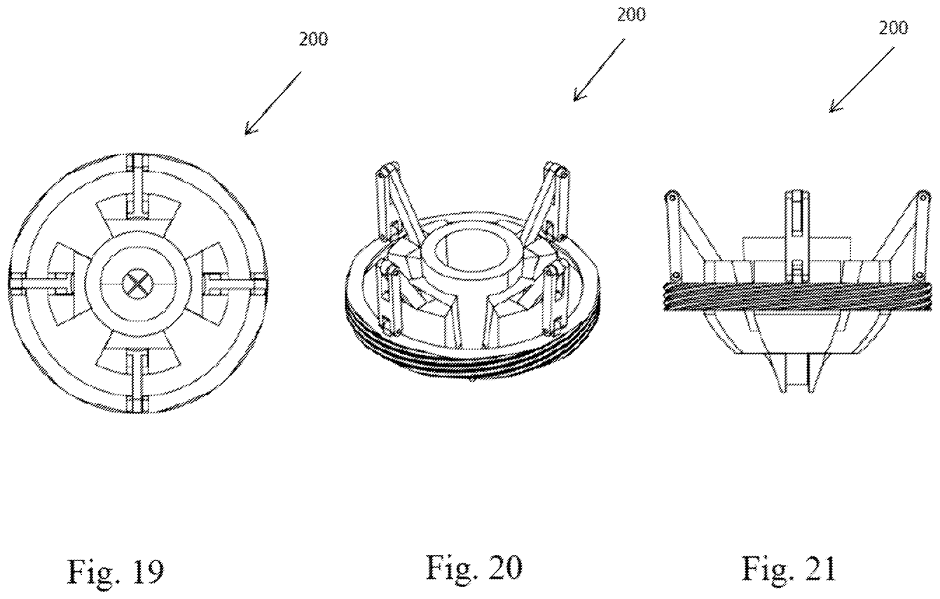

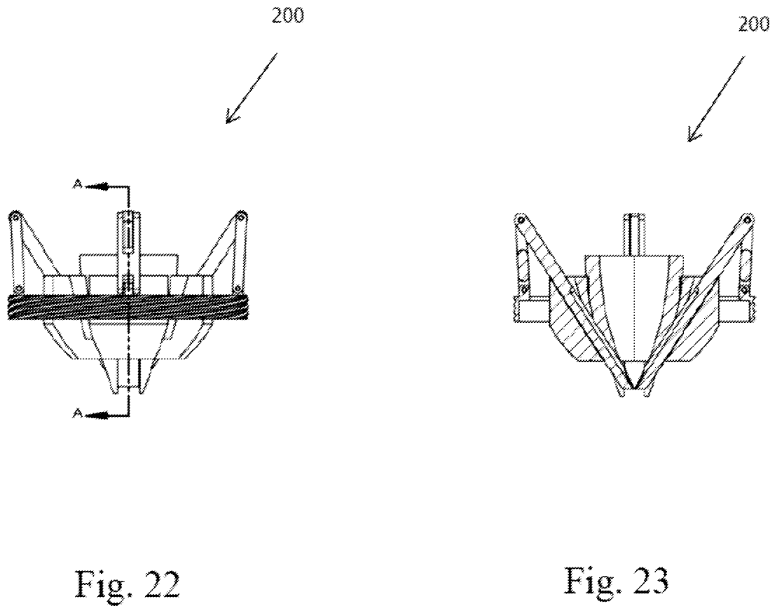

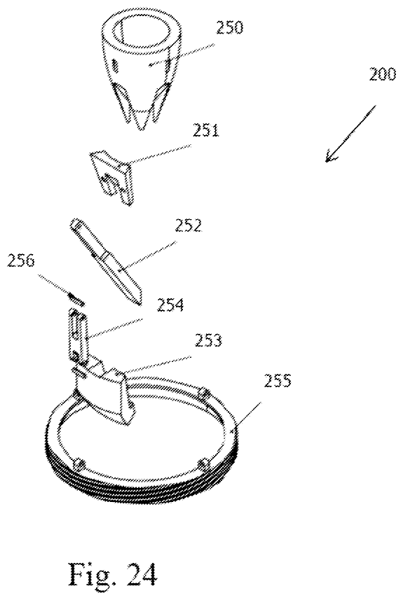

FIGS. 19 through 24 illustrate a further alternate embodiment 200 of the flow control system. This embodiment is different from embodiment 110 in that the jaws may not have the lip segment and as such may not prevent particle leakage between adjacent jaws at the nozzle opening. Also, the jaws may be at a different angle relative to the vertical axis. This design may also identify an alternate method of moving the outer control ring using threads. Specifically, this embodiment may comprise a funnel 250, a plurality of inner jaw guides 251, a plurality of jaws 252, a plurality of outer jaw guides 253, a plurality of brackets 254, an actuating collar 255, which may be threaded, and a plurality of pins 256.

As for further future applications of the present invention, any industry in which particles are involved and the particle flow rate control and distribution are important could benefit, such as grain silos, etc.

Whereas, the invention has been described in relation to the drawings attached hereto, it should be understood that other and further modifications, apart from those shown or suggested herein, may be made within the scope of this invention.

What is claimed is:

1. A particulate material flow control system, which material flow control system comprises:
an elongated flow control body, said body having an axial passage therethrough;
a plurality of fingers, each of said plurality of fingers received in either:
an opening passing through said flow control body into said axial passage, each said opening at an angle to said axial passage; or
a guide attached to an exterior of said flow control body, each said guide at an angle to said axial passage,
wherein said plurality of fingers together form a nozzle for passage of particulate material therethrough; and
a mechanism to actuate movement of each of said plurality of fingers relative to said elongated flow control body.

2. The particulate material flow control system as set forth in claim 1 wherein each said opening in said elongated flow control body or guide attached to said flow control body is at an acute angle to said axial passage of said body.

3. A material flow control system including a solar receiver, a heat exchanger, and low temperature storage, which material flow control system comprises:
an elongated flow control body, said body having an axial passage therethrough, wherein said axial passage is in communication with said heat exchanger and in communication with said low temperature storage;
a plurality of fingers, each of said plurality of fingers received in either:
an opening passing through said flow control body into said axial passage, each said opening at an angle to said axial passage; or
a guide attached to an exterior of said flow control body, each said guide at
an angle to said axial passage,
wherein said plurality of fingers together form a nozzle for passage of heat transfer material therethrough; and
a mechanism to actuate movement of each of said plurality of fingers relative to said elongated flow control body.

4. The material flow control system as set forth in claim 3 wherein each said opening in said elongated flow control body or guide attached to said flow control body is at an acute angle to said axial passage of said body.

5. The material flow control system as set forth in claim 3 wherein said heat transfer material is chosen from the group consisting of: solid particles, air, water/steam, molten salt, and oils.

6. The material flow control system as set forth in claim 5 wherein said heat transfer material is solid particles and wherein said solid particles are ceramic or silica based particles.

7. The material flow control system as set forth in claim 3 wherein said heat transfer material falls by gravity from high temperature storage, through said heat exchanger, through said flow control body and to said low temperature stage.

8. The material flow control system as set forth in claim 7 wherein said flow control material is transported from said low temperature storage to a solar receiver, and thereafter falls by gravity to said high temperature storage, and wherein said flow control material moves in a continuous cycle.

9. The material flow control system as set forth in claim 8 wherein said heat transfer material, said high temperature storage, said flow control body, said low temperature storage, and said solar receiver operate with a concentrating solar system.

10. The material flow control system as set forth in claim 3 wherein said openings or guides and said fingers are arranged in a radial pattern.

11. The material flow control system as set forth in claim 3 wherein each of said plurality of fingers has external notches or teeth.

12. The material flow control system as set forth in claim 3 wherein each of said plurality of fingers has external threads.

13. The material flow control system as set forth in claim 3 wherein each of said plurality of fingers terminates in a tapered chamfered tip.

14. The material flow control system as set forth in claim 3 wherein each of said plurality of fingers terminates in an arcuate shaped tip.

15. A concentrating solar power system which comprises:
a solar receiver;
high temperature storage;
a heat exchanger;
low temperature storage; and
an elongated flow control body, said body having an axial passage therethrough, wherein said axial passageway is in communication with said heat exchanger and in
communication with said low temperature storage;
a plurality of fingers, each of said plurality of fingers received in either:
an opening passing through said flow control body into said axial passage, each said opening at an angle to said axial passage; or
a guide attached to an exterior of said flow control body, each said guide at an angle to said axial passage,
wherein said plurality of fingers together form a nozzle for passage of heat transfer material therethrough; and
a mechanism to actuate movement of each of said plurality of fingers relative to said elongated flow control body.

16. The concentrating solar power system as set forth in claim 15 wherein each said opening in said elongated flow control body or guide attached to said flow control body is at an acute angle to said axial passage of said body.

17. The concentrating solar power system as set forth in claim 15 wherein the heat transfer material is chosen from the group consisting of: solid particles, air, water/steam, molten salt, and oils.

18. The concentrating solar power system as set forth in claim 17 wherein said heat transfer material is solid particles and wherein said solid particles are ceramic or silica-based particles.
